(19) United States
(12) Patent Application Publication
(10) Pub. No.: US 2007/0061800 A1
(43) Pub. Date: Mar. 15, 2007

(54) SYSTEM AND METHOD FOR UPDATING SOFTWARE IN A NETWORK DEVICE

(75) Inventors: SHU-MIN CHENG, TU CHENG (TW); CHI-HAN HUANG, TU CHENG (TW); CHIH-HAO CHEN, TU CHENG (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., TU CHENG (TW)

(21) Appl. No.: 11/308,696

(22) Filed: Apr. 22, 2006

(30) Foreign Application Priority Data
Sep. 9, 2005 (CN) 200510037241.4

(51) Int. Cl. G06F 9/44

(52) U.S. Cl. 717/170

(57) ABSTRACT

A network device including a software updating module for automatically updating software of the network device so that the software corresponds with that of a server side is provided. The software updating module includes a version file downloading unit for downloading a new version file from the server side, a main checking unit for checking whether the new version file exists, a software downloading unit for downloading new software, and a main updating unit for updating the software of the network device. A method of updating the software using the software updating module is also provided. Compared with a manual updating method, the network device and the software updating method thereof may automatically update the software, which makes them more safe, reliable and simple.

### FIELD OF THE INVENTION

The invention relates to a system and method for updating software, and more particularly to a system and method for automatically updating software in a network device.

### DESCRIPTION OF RELATED ART

Network devices such as digital set-top boxes, cable modems, and asymmetric digital subscriber line modems (ADSL modems), and so on include kernel software and non-kernel software including applications and drivers, etc. When using these devices, users often encounter some problems such as meeting requirements for adding software in the network device to enhance its functionality, or updating a version of the software to increase data transmission rate. Therefore, it is important to timely and efficiently add the software, or update the software version. In general, software updating is performed by a user. People undertaking an updating process should have relevant technical knowledge to ensure the reliability of their efforts to update the software. A risk of damaging the network device if the updating is performed by an unskilled user exists.

### SUMMARY OF INVENTION

One aspect of the invention provides a network device that includes a software updating module for automatically updating software of the network device so that the software corresponds with software of a server side is provided. The software updating module includes a version file downloading module for downloading a new version file, a main checking module for checking the new version file of a new software, a software downloading module for downloading the new software, and a main updating module for updating the software in the network device.

Advantageously, the network device further includes a decryption module for decrypting the new version file, a verification module for verifying validity of the new software, and a kernel software checking module for checking whether the new software is kernel software. The main checking module further includes a new-added software checking module for checking whether the new version file includes a new-added software, and a version checking module for checking whether the new version file includes new version software. The main updating module further includes a kernel software updating module for updating kernel software, and a non-kernel updating software for updating non-kernel software.

Another aspect of the invention provides a software updating method, which updates the software of the network device using the software updating module, so that the software of the network corresponds to that of the server side. The method includes downloading the new version file from the server side, checking the new version file to determine whether new software exists, downloading the new software when the new software exists, and updating the software of the network device.

Advantageously, the method further includes checking whether the new version file includes the new-added software, checking whether the new version file includes the new version software, verifying the validity of the new-added software, checking whether the new-added software is the kernel software, updating the kernel software if the new-added software is the kernel software, and updating the software if the new-added software is not the kernel software. The kernel software updating process further includes writing the kernel software to a storage device of the network device, updating kernel software information in an old version file, deleting a temporary folder in the network device, and restarting the network device. The non-kernel updating process further includes updating the old version file and identifying the corresponding software as “ALREADY UPDATED”.

Other advantages and novel features will become more apparent from the following detailed description when taken in conjunction with the accompanying drawings, in which:

### BRIEF DESCRIPTION OF DRAWINGS

FIG. 1 is a schematic diagram of a software updating module of a network device of the invention;

FIG. 2 is a flow chart of updating software using a software updating module of a network device of the invention; and

FIG. 3 is a flow chart of updating kernel software using a kernel software updating unit of a network device of the invention.

### DETAILED DESCRIPTION

Current network devices each have a version file of software stored therein. In the embodiment, in order to implement automatic updating of software, information stored in the version file of a network is compared with that in a server side, item by item. The information stored in the version file includes: file name, which is a name of the software stored in the network device; version, in updating the software, the network device compares a software version of the server side with that of the network device using the version information, to determine whether a new software version is required; date, which is launching date of a corresponding version software; path, which is a folder in which the software should be located; digest, which is a verification string for confirming whether the software is appropriate or not, such as Message Digest Algorithm 5 (MD5) verification; and comment, which is used as further explanation of the software.

The network device in the embodiment may be a set top box, an asymmetric digital subscriber line (ADSL) modem, a cable modem, etc.

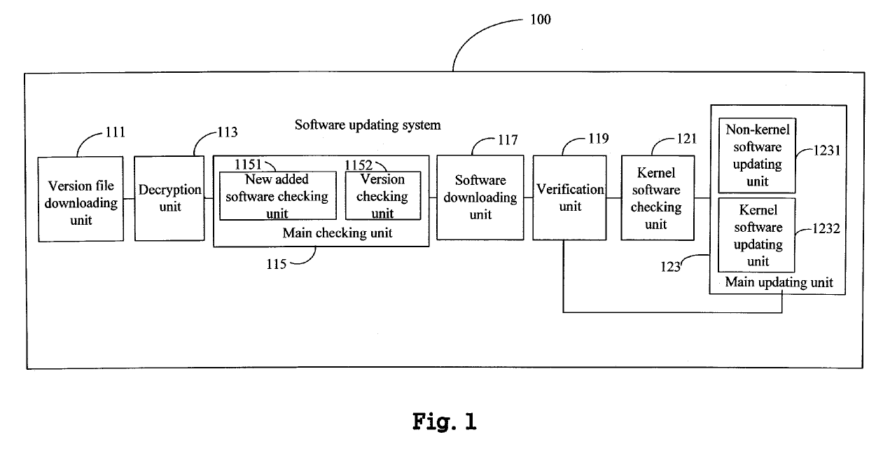

Now referring to FIG. 1, a schematic diagram illustrating a software updating system 100 in the network device according to an embodiment of the invention is shown. In the exemplary embodiment, the software updating system 100 is used to update the software of the network device to correspond with that of the server side. The software updating system 100 includes a version file downloading unit 111, a decryption unit 113, a main checking unit 115, a software downloading unit 117, a verification unit 119, a kernel software checking unit 121, and a main updating unit 123. The main checking unit 115 includes a new added software checking unit 1151 and a version checking module 1152, and the main updating module 123 includes a non-kernel software updating unit 1231 and a kernel software updating unit 1232.

In an embodiment of the invention, the version file downloading unit 111 is used to download a new version file from the server side, and the decryption unit 113 is used to decrypt the new version file. The main checking unit 115 is used to check whether there is information on new software in the decrypted new version file. The new-added software checking unit 1151 is used to check whether there is new-added software in the decrypted new version file, and the version checking unit 1152 is used to check whether there is new version software in the decrypted new version file. The information downloading unit 117 is used to download the new-added software and the new version software. The verification unit 119 is used to verify the validity of the software downloaded by the software downloading unit 117. In this embodiment, the verification unit 119 uses a Message Digest Algorithm 5 (MD5) algorithm to verify the validity of the software. The kernel software checking unit 121 is used to check whether the software passing the above verification is kernel software. The non-kernel software updating unit 1231 of the main updating module 123 is used to update non-kernel software, while the kernel software updating unit 1232 is used to update kernel software.

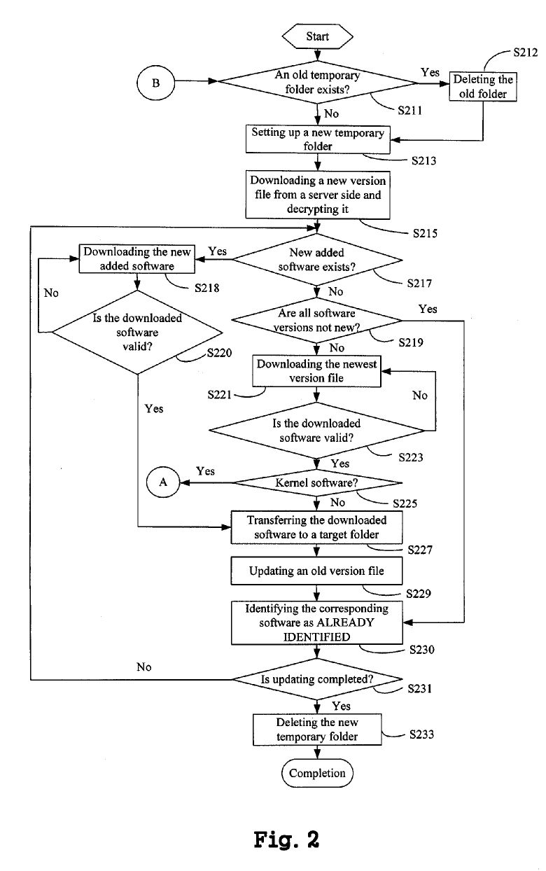

Now referring to FIG. 2, FIG. 2 is a flow chart of updating software using a software updating module of a network device 10 of the invention . In this exemplary embodiment, before updating the software, the network device has an initial version file. The software updating module 100 sets up a temporary folder before updating the software. The temporary folder is used for storing the version file or the software downloaded from the server side in the following updating process. Following the completion of the software updating, the network device transfers all data in the temporary folder to a target folder, and then deletes the temporary folder. In this embodiment, different software corresponds to different target folders.

When the network device is enabled, the process starts at step S211, where the software updating module 100 checks whether there is an old temporary folder in a storage device of the network device. If the software updating module 100 determines there is an old temporary folder, the process proceeds to step S212, where the old temporary folder is deleted to ensure that there is enough space in the storage device of the network device to complete the updating process. After the old temporary folder is deleted by the software updating module 100, in step 213, a new temporary folder is set up. In step S211, if no old temporary folder is detected by the software updating module 100, then the process proceeds to step S213, and a new temporary folder is set up.

The process then enters step S215, where the file downloading unit 111 downloads a new version file from the server side based on the trivial file transfer protocol (TFTP), and places it into the temporary folder set up in step S213, then the decryption unit 113 decrypts this new version file.

The process then proceeds to step S217, where the new added software checking unit 1151 checks whether the new-added software exists. Specifically, the new-added software checking unit 1151 chronologically or alphabetically arranges software information listed in the old and the new version file, and then compares the number of software listed in these version files to check whether the new-added software exists. The process then proceeds to step S218, where the software downloading unit 117 downloads the new-added software. If there is a plurality of software to be downloaded, it is done so one at a time. Downloaded software is placed in the temporary folder. Each time software is downloaded, a verification unit 119 checks the validity of the downloaded software in S220. If the downloaded software is valid, the process proceeds to step S227, where the downloaded software is transferred to a target folder. If not, the process returns to step S218, where the software that failed the verification is re-downloaded by the software downloading unit 117.

In step S217, if the comparison finds that the number of the software listed in the new version file is the same as that of a corresponding old version file, then there is no new added software of the server side. The process then proceeds to step S219, where the version checking unit 1152 compares the software version of the new version file with that of the old version file, one by one, according to the version information in the version file. If the software version in the new version file is not new in comparison with the corresponding one in the old version file, the process directly proceeds to step S230, where the software is identified as ALREADY UPDATED.

If the version checking unit 1152 discovers that the software version in the new version file is new in comparison with the corresponding one in the old version file, then the process proceeds to step S221, where the software downloading unit 117 downloads the newest version software from the server side based on the TFTP. Upon the completion of the downloading, the process proceeds to step S223, where the verification unit 119 verifies the validity of the downloaded software, if the downloaded software is valid, the process proceeds to step S225, if invalid, the process returns to step S221.

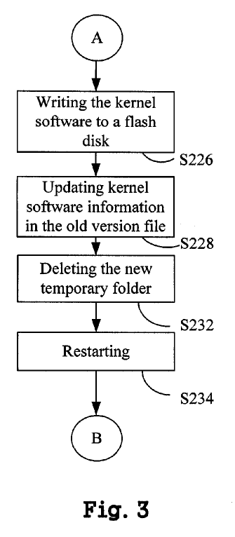

In step S225, the kernel software checking unit 121 checks the software downloaded by the software downloading unit 117 in step S221, to determine whether the downloaded software is the kernel software. Referring to FIG. 3, the downloaded software will enter a node A if it is the kernel software.

In step S225, if the kernel software checking unit 121 determines the downloaded software is the non-kernel software, the process directly proceeds to step S227, where the downloaded software is transferred to the target folder.

In step S227, after the software updating module 100 transfers the downloaded software to the target folder, the process proceeds to step S229, where the software updating module 100 updates the information of the corresponding software in the old version file thereof, then the process proceeds to step S230, where the software is identified as ALREADY UPDATED. The process then proceeds to step S231, where the software updating module 100 checks whether all the software has been updated according to the number of the software listed in the new version file. If the updating is not complete, the process returns to step S217 and starts the updating of the next software. If the updating is complete, the process proceeds to step S233, where the temporary folder built in step S213 is deleted, and the updating process finishes. Following the completion of the software updating, the software information in the old version file, which includes the number and version of the software, is the same as that in the new version file.

Now referring to FIG. 3, FIG. 3 is a flow chart of updating kernel software using a kernel software updating unit of a network device 10 of the invention. In step S225, the process begins at the node A shown in FIG. 2, and then proceeds to step S226, where the kernel software updating unit 1232 writes the downloaded kernel software to a flash disk, the process then proceeds to step S228, where the kernel software updating unit 1232 updates the kernel software information in the old version file. The process then proceeds to step S232, where the software updating unit 1232 deletes the temporary folder built in step S213. The process then proceeds to step S234, where the kernel software updating unit 1232 is restarted to ensure the proper operation of the downloaded kernel software. The process ends at the node B shown in FIG. 2 to perform the next updating.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments.

What is claimed is:

1. A software updating system for automatically updating software in a network device, the software updating system comprising:
a version file downloading unit for downloading a new version file from a server side;
a main checking unit for checking whether there is new software in the new version file;
a software downloading unit for downloading the new software; and
a main updating unit for updating the software of the network device.

2. The software updating system according to claim 1, wherein the software updating module further comprises a decryption unit for decrypting the new version file.

3. The software updating system according to claim 1, wherein the new software comprises either or both of new-added software and new version software.

4. The software updating system according to claim 3, wherein the main checking unit further comprises:
a new-added software checking unit for checking whether the new version file comprises the new added software, and
a version checking unit for checking whether the new version file comprises the new version software.

5. The software updating system according to claim 1, wherein the software updating module further comprises a verification unit for verifying the validity of the new software.

6. The software updating system according to claim 5, wherein the new software comprises either or both of kernel software and non-kernel software.

7. The software updating system according to claim 6, wherein the software updating module further comprises a kernel software checking unit for checking whether the new software is kernel software.

8. The software updating system according to claim 6, wherein the main updating unit further comprises:
a kernel software updating unit for updating the kernel software; and
a non-kernel updating unit for updating the non-kernel software.

9. A software updating method for updating software of a network device, comprising the steps of:
downloading a new version file from a server side;
checking the new version file to determine whether new software exists;
downloading the new software if the new software exists; and
updating software of the network device.

10. The software updating method according to claim 9, further comprising the step of decrypting the new version file.

11. The software updating method according to claim 9, wherein the new software comprises new-added software and new version software.

12. The software updating method according to claim 11, further comprising the step of checking whether the new version file comprises the new-added software.

13. The software updating method according to claim 11, further comprising the step of checking whether the new version file comprises new version software.

14. The software updating method according to claim 9, further comprising the step of verifying the validity of the new added software.

15. The software updating method according to claim 9, wherein the new software comprises either or both of kernel software and non-kernel software.

16. The software updating method according to claim 15, further comprising the step of checking whether the new software is kernel software.

17. The software updating method according to claim 16, further comprising updating the kernel software if the new software is kernel software.

18. The software updating method according to claim 17, wherein updating the kernel software comprises:
writing the kernel software to a storage device of the network device;
updating kernel software information in an old version file; and
deleting a temporary folder in the network device.

19. The software updating method according to claim 16, further comprising updating the non-kernel software if the new software is non-kernel software.

20. The software updating method according to claim 16, further comprising the steps of:
transferring the non-kernel software to a target folder; and
updating the new version file.
